(19) United States
(12) Patent Application Publication
(10) Pub. No.: US 2011/0235201 A1
(43) Pub. Date: Sep. 29, 2011

(54) TWO-IMAGE-POINT IMAGING OPTICAL DEVICE

(75) Inventor: Satoshi Maekawa, Tokyo (JP)

(73) Assignee: National Institute of Information and Communications Technology, Koganei-shi (JP)

(21) Appl. No.: 12/671,828

(22) PCT Filed: Aug. 6, 2008
(86) PCT No.: PCT/JP2008/064105

§ 371 Date: Feb. 2, 2010

(30) Foreign Application Priority Data
Aug. 7, 2007 (JP) 2007-204996

(51) Int. Cl. G02B 5/08

(52) U.S. Cl. 359/851

(57) ABSTRACT

A two-image-point imaging optical device forms a real image in space on the same side as a point light source with respect to one plane on the device and a virtual image in space on the opposite side. In the two-image-point imaging optical device, multiple dihedral corner reflectors each comprising two mutually perpendicular planar specular surfaces are so disposed that the line of intersection between the two specular surfaces of each dihedral corner reflector is parallel with those of the others on a first plane. A virtual image is formed in space on the side opposite to the point light source which the two specular surfaces face with respect to the first plane and a real image is formed in space on the same side as the point light source. This enables the virtual and the real images that lie on a straight line to be observed from a viewpoint in the space on the same side as the point light source.

### FIELD OF THE INVENTION

The present invention is related to an optical device having two image points and forming a real image in space on the same side as a point light source with respect to a given one plane and a virtual image in space on the side opposite to the point light source.

### BACKGROUND OF THE INVENTION

The inventor of the present invention has proposed an imaging optical device that uses numerous specular surfaces arranged normal to the optical device plane and in parallel with one another to form a real image and a virtual image at a time (see for example Patent Reference No. 1). The imaging optical'device is a two-image-point imaging optical device that, when viewed from above the optical device plane from the direction facing the specular surfaces, provides in space under the optical device plane a virtual image of an object to be projected placed under the optical device plane for a parallax parallel to the optical device plane and a real image of the object in space above the optical device plane for a parallax perpendicular to that parallax.

Patent Reference No. 1: JP 2006-271191

### SUMMARY OF THE INVENTION

### Problem to be Solved by the Invention

The two-image-point imaging optical device can be used as an optical device that provides a real image in a simple manner. However, since a virtual image is provided for a parallax parallel to the optical device plane, the image cannot be observed as an image floating in midair over the plane. To provide a real image by the optical device, the optical device is placed on a wall, for example. The real image is observed as if it were a three-dimensional object in front of the wall.

In light of the problem described above, a main purpose of the present invention is to provide an optical device having two image points and providing a real image when viewed with a parallax parallel to the optical device plane.

### Means for Solving the Problem

A two-image-point imaging optical device according to the present invention includes a plurality of dihedral corner reflectors. Each of the dihedral corner reflectors includes two planer specular surfaces perpendicular to each other. The dihedral corner reflectors are disposed so that the line of intersection between the two specular surfaces of every dihedral corner reflector is in parallel to that of every other dihedral corner reflector on a first single plane to enable an image to be formed by light emitted from a point light source disposed in space faced by the two specular surfaces with respect to the first plane and reflected once at each of the two specular surfaces of each of the dihedral corner reflectors. The image is observable from a viewpoint set in space on the same side as the point light source with respect to the first plane. A virtual image is formed at a point line-symmetric to the point light source with respect to the line of intersection between the first plane and a second plane that is in parallel to the line of intersection between the two specular surfaces on the first plane and includes the point light source and the viewpoint. A real image is formed at the point of intersection between a line including the virtual image and the viewpoint and a line that is parallel to the line of intersection between the two specular surfaces including the point light source. Both of the virtual image and the real image are observable from the viewpoint. The first plane is the optical device plane of the two-image-point imaging optical device of the present invention.

In the two-image-point imaging optical device, when an object to be projected (which may be a two-dimensional or three-dimensional physical object or image) is placed in space on one side of a given plane (a first plane), that is, space faced by the two specular surfaces of the dihedral corner reflector, light emitted from one point (point light source) on the object to be projected, spreading laterally (across each dihedral corner reflector), then reaching the viewpoint is reflected once at each of the two specular surfaces of each dihedral corner reflector. When being projected in the plane perpendicular to the line of intersection of each dihedral corner reflector, the light is retro-reflected and converges at one point in space on the same side as the point light source with respect to the first plane to form a real image. That is, if the object to be projected is a two-dimensional or three-dimensional physical object or image, the set of convergence points of light form a real image of the object to be projected. Light emitted from one point (point light source) on the object to be projected, spreading vertically (along the line of intersection of the two specular surfaces of the dihedral corner reflector), and then reaching the viewpoint is not transformed at all by the specular surfaces since the light spreads in parallel to the specular surfaces of the dihedral corner reflector. Because the specular surfaces act on the light like plain mirrors, the light forms a virtual image in space on the side opposite to the object to be projected with respect to the first plane. Here, the locations of the virtual and real images viewed from a view point on the same side as the object to be projected with respect to the first plane will be investigated. An imaginary second plane that is parallel to the line of intersection between the two specular surfaces on the first plane and includes the point light source and the viewpoint is assumed. The point that is line-symmetric to the point light source with respect to the line of intersection between the first and second planes is the point at which the virtual image is formed. The point of intersection between the line connecting the virtual image to the viewpoint and the line including the point light source and being parallel to the line of intersection between the two specular surfaces of the dihedral corner reflector is the point at which the real image is formed. The real image is a three-dimensional image reversed in depth if the object to be projected, which is a set of point light sources, is a three-dimensional physical object or image.

Since the virtual image and real image remain in line with the viewpoint regardless of the location of the viewpoint, the real image formed by laterally spreading light and the virtual image formed by vertically spreading light can be always observed on one straight line as the viewpoint is moved, as long as the viewpoint is in a position from which light emitted from the object to be projected and reflected by the dihedral corner reflector is visible in space on the same side as the object with respect to the first plane. The line of intersection between the two specular surfaces of the dihedral corner reflector is preferably positioned precisely on the first plane. However, the line of intersection may be at a slight distance from the first plane within an error range up to the height of the dihedral corner reflectors. The dihedral corner reflectors of the present invention are not limited to those in which two plain smooth planer reflecting mirror surfaces are disposed perpendicularly to each other so that light is reflected successively at each of the reflecting surfaces. The present invention also include a mode in which dihedral corner reflectors are made of a transparent material and have a cross-sectional profile with a vertex angle of 90 degrees and the two smooth surfaces forming the vertex angle totally reflect light. In the mode that uses total reflection, the two surfaces forming the right vertex angle function as the two specular surfaces of the dihedral corner reflector.

When the dihedral corner reflectors are disposed so that the internal corner formed by the two specular surfaces face in the same direction in space on the same side as the point light source with respect to the first plane, all the dihedral corner reflectors face in the same direction in space on the same side as the point light source. In particular, by disposing the dihedral corner reflectors so that the bisector of the internal angle formed by the two specular surfaces of the dihedral corner reflector coincides with the normal to the first plane, all the dihedral corner reflectors can be disposed perpendicularly to the first plane. In that case, image formation can be uniform independently of the location of the optical device plane, that is, the first plane, and an identical image can be formed in any positions.

All dihedral corner reflectors do not necessarily need to face in the same direction in line. Any of the dihedral corner reflectors may be oriented to any direction of rotation about the line of intersection between two specular surfaces of the dihedral corner reflector as long as the two specular surfaces face the point light source. The arrangement of the dihedral corner reflectors can provide the same effects of the present invention described above.

In particular, by directing the dihedral corner reflectors to a certain viewpoint or a position between the point light source and a certain viewpoint, the brightness of the image observed from that certain viewpoint can be increased and an image extending over a wider range can be presented, although the viewpoint is limited.

### Effects Achieved by the Invention

The two-image-point imaging optical device of the present invention is capable of forming a real image in space on the same side as an object to be projected to which the specular surfaces of the dihedral corner reflectors are directed with respect to the device while at the same time forming a virtual image in space on the opposite side, so that these image can be observed from the space on the same side as the object to be projected. In particular, an optical device can be constructed that is capable of providing a real image when viewed with a parallax parallel to a first plane, which is the optical device plane, so that the real image can be observed as an image floating in midair over the plane.

### BRIEF DESCRIPTION OF THE DRAWINGS

FIG. 1 is a perspective view schematically illustrating a portion of the two-image-point imaging optical device according to one embodiment of the present invention.

FIG. 2 is a cross-sectional view schematically illustrating the two-image-point imaging optical device.

FIG. 3 is a perspective view schematically illustrating the principle of image formation by the two-image-point imaging optical device.

FIG. 4 is a perspective view schematically illustrating light reflection by the dihedral corner reflector used in the two-image-point imaging optical device.

FIG. 5 is a diagram illustrating in further detail the principle of image formation by the two-image-point imaging optical system.

FIG. 6 is a schematic front elevation view of the two-image-point imaging optical device according to a variation of the embodiment.

FIG. 7 is a schematic diagram illustrating the two-image-point imaging optical device according to another embodiment of the present invention.

### DETAILED DESCRIPTION OF THE INVENTION

Embodiments of the present invention will be described below with reference to the drawings.

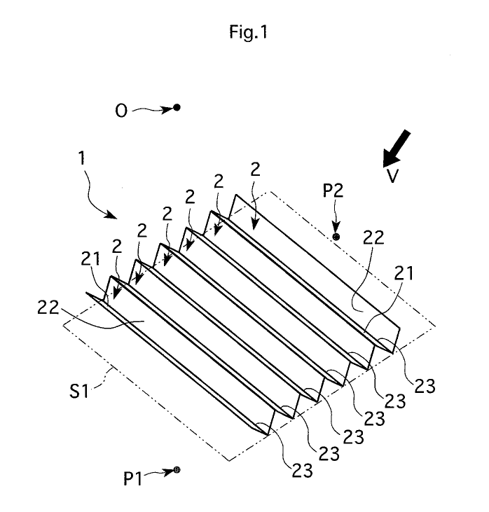

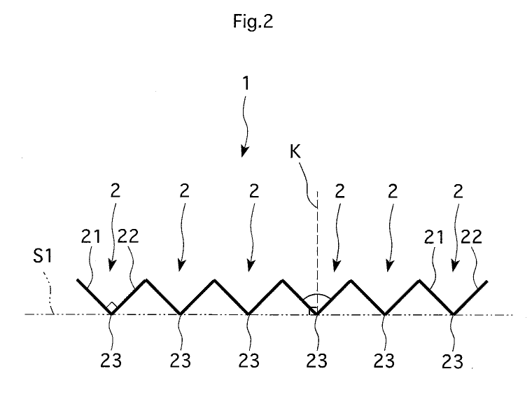

FIG. 1 is a perspective view schematically illustrating a portion of a two-image-point imaging optical device 1 according to the present embodiment. The two-image-point imaging optical device 1 uses reflection by mirrors to enable an image to be observed. The optical device includes numerous narrow dihedral corner reflectors 2 arranged in parallel to one another on a first plane S1, which is an imaginary plane. Specifically, as schematically illustrated in the cross-sectional view in FIG. 2, the line of intersection 23 between two mutually perpendicular specular surfaces 21 and 22 of each dihedral corner reflector 2 is on the first plane S1 and all lines of intersection 23 are parallel with one another. A virtual image P1 and a real image P2 of an object to be projected O (depicted as a point light source in FIG. 1, hereinafter sometimes called “point light source O” as needed) placed in space on one side of the first plane S1 (above the first plane S1 in the example depicted) are formed in space on the side opposite to the object to be projected O (under the first plane S1) and in space on the same side as the object to be projected O (above the first plane S1), respectively. These images are observable from a viewpoint V in space on the same side of the first plane S1 as the object to be projected O (above the plane S1). While the dihedral corner reflectors are actually very narrow, their size in the figure is exaggerated for the sake of clarity. It can be said that the first plane S1 is the optical device plane of the two-image-point imaging optical device 1.

A configuration of the two-image-point imaging optical device 1 of the present embodiment will be described below. All of the multiple dihedral corner reflectors 2 of the two-image-point imaging optical device 1 are identical. Each of the dihedral corner reflectors 2 includes two very narrow rectangular mirrors so disposed that their specular surfaces 21 and 22 are perpendicular to each other. Each specular surface 21, 22 is approximately 100 μm in width (short side) and several to a little more than 10 cm in length (long side). The dihedral corner reflectors 2 are disposed so that the line of intersection 23 between the specular surfaces 21 and 22 of every dihedral corner reflector 2 at which they are joined together is parallel to those of the other dihedral corner reflectors 2 on the first plane S1 and the bisector of the internal angle between the two specular surfaces 21 and 22 of every dihedral corner reflector coincides with the normal K to the first plane S1. The two-image-point imaging optical device 1 can be fabricated for example by a nano-scale pressing process called nano-imprint process or by an electroforming process using a metal mold in which right-angled ridges corresponding to the grooves between two adjacent specular surfaces 21, 22 of the dihedral corner reflectors 2 are arranged in parallel with one another. The surfaces to be formed into the specular surfaces 21, 22 are preferably processed by nano-scale cutting into mirror surfaces with a surface roughness of 10 nm so as to serve as specular surfaces that uniformly function for the entire band of the visible spectrum. If the electroforming process is used to fabricate the two-image-point imaging optical device 1 from a metal plate such as an aluminum or nickel plate, the specular surfaces 21, 22 are naturally created by the mold, provided that the surface roughness of the mold is sufficiently low. If the nano-imprinting process is used to fabricate the two-image-point imaging optical device 1 from a resin plate, the surfaces are preferably coated with a mirror coat by using a process such as sputtering to complete the specular surfaces 21, 22.

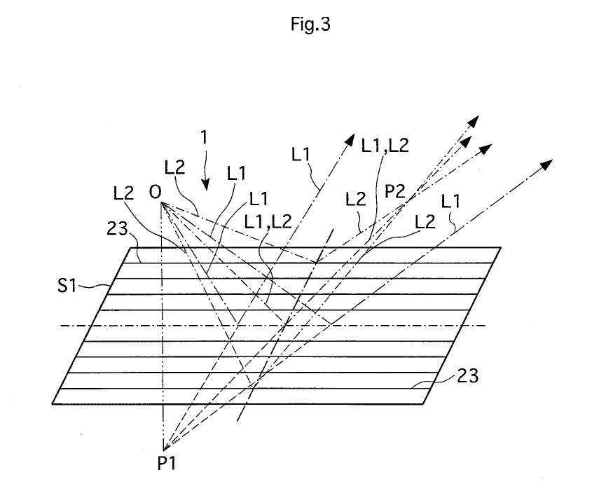

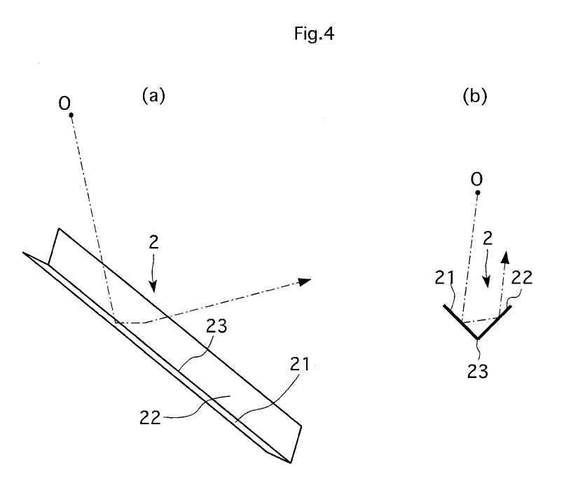

The principle of image formation by the two-image-point imaging optical device 1 of the present embodiment will be described next. It is assumed here that the object to be project is a point light source O. Since the individual dihedral corner reflectors 2 are of minute dimensions as compared with the entire two-image-point imaging optical device 1, they are depicted in a simplified manner in FIG. 3. When the point light source O is placed in space above the first plane S1 as depicted in FIG. 3, light (light rays L2) that spreads from the point light source O laterally, that is, in the direction perpendicular to the line of intersection 23 of the specular surfaces 21, 22, is reflected once at each of the two specular surfaces 21 and 22 of each dihedral corner reflector 2 to converge at one point (P2) in space on the same side as the point light source O with respect to the first plane S1 as illustrated in the perspective view in FIG. 4(a) and in the plan view in FIG. 4(b). The convergence point P2 is the point at which the light from the point light source O forms a real image. On the other hand, the dihedral corner reflectors 2 acts on light (light rays L1) that spreads from the point light source O vertically, that is, in the direction parallel to the line of intersection 23 between the two specular surfaces 21, 22, in the same manner as plain plane mirrors. Accordingly, the light forms a virtual image in the position line-symmetric to the point light source O with respect to the axis of symmetry, which is the line consisting of a set of intersection points between light rays L1 and the first plane S1, on the first plane S1 parallel to the line of intersection 23. The virtual image P1 and the real image P2 will appear always on the same line from any viewpoints in space on the same side as the point light source O with respect to the first plane S1.

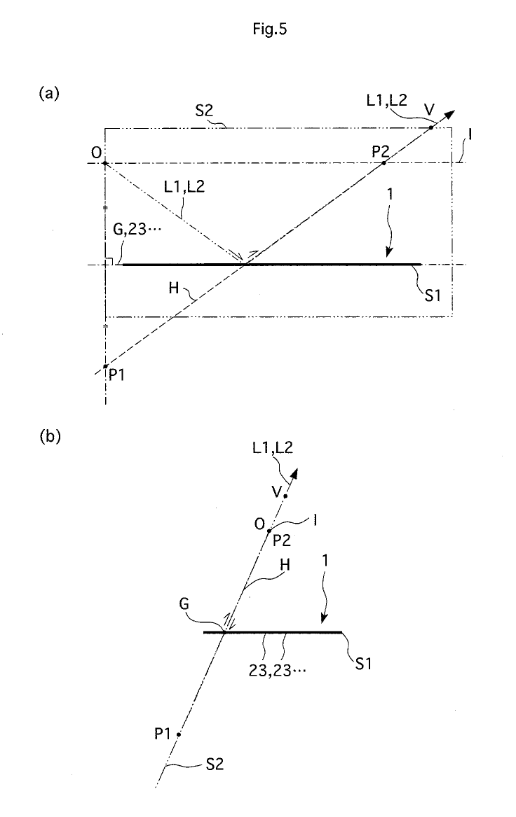

Image formation by the two-image-point imaging optical device 1 and positional relationship between the virtual image P1 and the real image P2 observed from a certain viewpoint V will be described in detail. The dihedral corner reflectors 2 (specular surfaces 21, 22 and lines of intersection 23) are omitted from FIG. 5. Assumption here is that, as illustrated in the side elevation view in FIG. 5(a) and the front elevation view in FIG. 5(b), the view point V is placed in space on the same side as the point light source O to which the two specular surfaces 21 and 22 of the dihedral corner reflector 2 are directed, with respect to the first plane S1 on which the lines of intersection 23 between the specular surfaces 21, 22 of the dihedral corner reflectors 2 lie in parallel with one another. An imaginary second plane S2 that includes the point light source O and the view point V and is parallel to the lines of intersection 23 on the first plane S1 is provided. As illustrated in FIG. 5, depending on the viewing direction from the viewpoint V, the first and second planes S1 and S2 are not necessarily perpendicular to each other. The virtual image P1 is formed in a position line-symmetric to the point light source O with respect to the line of intersection G between the first plane S1 and the second plane S2. On the other hand, when an imaginary line H including the virtual image P1 and the viewpoint V is drawn and an imaginary line I including the point light source O and being parallel to the line of intersection 23 between the two specular surfaces 21 and 22 is drawn, the point of intersection between the lines H and I is the point at which the real image P2 is formed. That is, the virtual image P1 and the real image P2 are observable on the straight line viewed from the viewpoint V. As long as the two-image-point imaging optical device 1 is used and a view point V is set in a position from which the virtual image P1 and the real image P2 are observable, the linear positional relationship among the viewpoint V, virtual image P1 and real image P2 is maintained.

Given that the object to be projected which is a two-dimensional or three-dimensional physical object or image is a set of point optical sources O, and if the object is a three-dimensional, the image P 2 will be a depth-reversed image. Especially because the real image P2 is formed in space on the same side as the object to be projected with respect to the first plane S1, an observer can virtually access the real image P2.

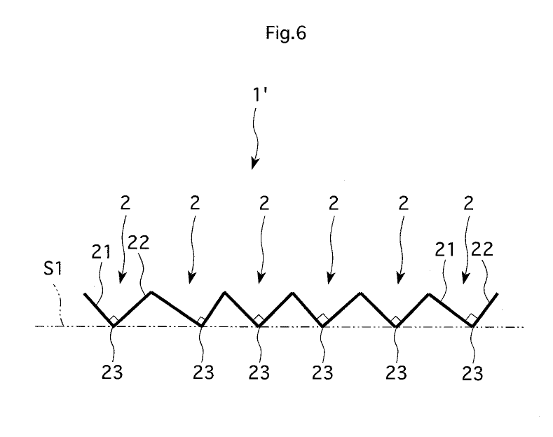

The present invention is not limited to the embodiment described above. For example, while the two specular surfaces 21 and 22 of the dihedral corner reflector 2 are joined together at their lower long sides and the junction is indicated as the line of intersection 23 in the example described above, the specular surfaces 21 and 22 may be slightly spaced apart. In that case, the intersection between imaginary extensions from the two specular surfaces 21 and 22 may be considered as the line of intersection 23. The line of intersection 23 can be slightly displaced from the first plane S1 to an extent near the height of the dihedral corner reflector 2. FIG. 6 illustrates a front elevation view of a two-image-point imaging optical device 1′ of a variation of the embodiment described above. As illustrated, all dihedral corner reflectors 2 do not necessarily face in the same direction. The dihedral corner reflectors 2 may be oriented to any direction of rotation about the line of intersection 23 as long as the line of intersection 23 between the two specular surfaces 21 and 22 of every dihedral corner reflector is parallel to the line of intersection 23 of every other dihedral corner reflector and the internal corner between the two specular surfaces 21 and 22 face the space on one side of the first plane S1 (the space above the first plane S1). The configuration has effects similar to those of the embodiment described above. Although not depicted, an alternative mode may be used in which dihedral corner reflectors 2 having long sides shorter than those illustrated in the above embodiment are randomly arranged, provided that the line of intersection 23 between two specular surfaces 21 and 22 of every dihedral corner reflector 2 is in parallel with the line of intersection 23 of every other dihedral corner reflectors on the first plane S1.

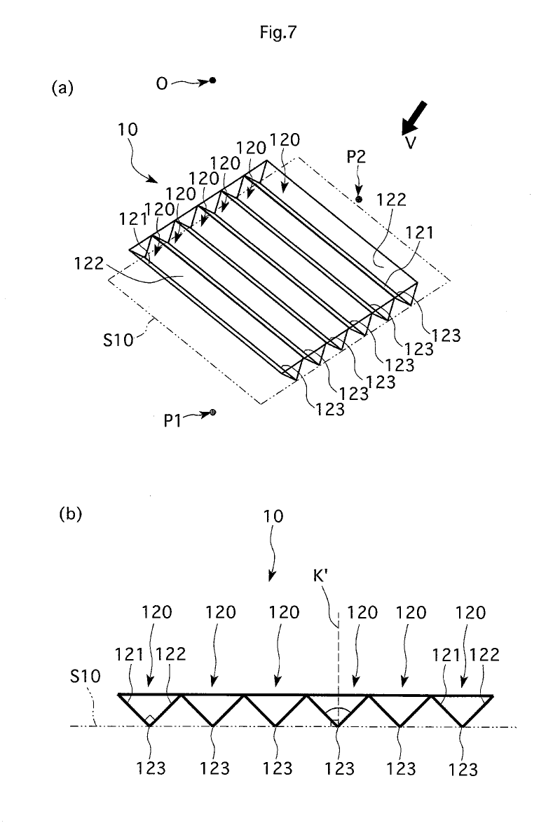

In addition to the mode that uses reflections by two mirrors as described above, an alternative embodiment of the present invention is possible in which total reflection of light is used. A two-image-point imaging optical device 10 of an embodiment illustrated in FIG. 7 includes multiple dihedral corner reflectors 120 which are triangular prisms each having a medium of a transparent material such as glass, quartz or resin with a refractive index greater than 1 and having a right isosceles triangular cross-section. The dihedral corner reflectors 120 are so disposed that the right angle vertex of each prism points downward. In each of the dihedral corner reflectors 120, the two surfaces that form the right angle vertex functions as specular surfaces 121 and 122. In this two-image-point imaging optical device 10, the multiple dihedral corner reflectors 120 having the same configuration are arranged on the same plane (first plane S10) so that the line of intersection 123 between the two specular surfaces 121 and 122 of every dihedral corner reflector 120 are arranged in parallel with that of other dihedral corner reflectors. Accordingly, the upper surface of the two-image-point imaging optical device 10 is planar. The principle of formation of virtual and real images of a point light source by this two-image-point imaging optical device 10 is the same as that of the embodiment described above, except that total light reflection is used instead of reflection of light by mirrors illustrated in FIGS. 3, 4 and 5. The positional relationship between image points of virtual and real images P1 and P2 and the viewpoint V is exactly the same as that in the embodiment described above. The bisector between the two specular surface 121 and 122 of every dihedral corner reflector 120 coincides with the normal K′ to the first plane 10 in the present embodiment. However, dihedral corner reflectors having two mutually perpendicular specular surfaces that are tilted in an appropriate direction about the rotation axis that is the line of intersection may be used as in the two-image-point imaging optical device 1′ illustrated in FIG. 6. Alternatively, a configuration may be used in which numerous dihedral corner reflectors which are minute triangular prisms having a cross section in the shape of a right isosceles triangle are disposed so that the side including the right angle vertex of every dihedral corner reflector is in parallel to that of the every other dihedral corner reflector on the same plane (first plane).

Specific configurations of other components of the present invention are not limited to those in the embodiments described above; variations can be made without departing from the spirit of the present invention.

### INDUSTRIAL APPLICABILITY

The present invention can be used as devices such as a display device that uses an optical device having two image points and being capable of providing a real image observable with a parallax parallel to the optical devices plane, thereby enabling an observer to observe both the real and virtual images from the same position.

1. A two-image-point imaging optical device comprising a plurality of dihedral corner reflectors each including two planer specular surfaces perpendicular to each other, said plurality of dihedral corner reflectors being disposed so that the line of intersection between said two specular surfaces of every dihedral corner reflector is in parallel to that of every other dihedral corner reflector on a first single plane to enable an image to be formed by light emitted from a point light source disposed in space faced by said two specular surfaces with respect to said first plane and reflected once at each of the two specular surfaces of each of said dihedral corner reflectors, said image being observable from a viewpoint set in space on the same side as the point light source with respect to the first plane, wherein:
a virtual image is formed at a point line-symmetric to said point light source with respect to the line of intersection between said first plane and a second plane that is in parallel to the line of intersection between said two specular surfaces on said first plane and includes said point light source and said viewpoint;
a real image is formed at the point of intersection between a line including said virtual image and said viewpoint and a line that is parallel to said line of intersection between said two specular surfaces including said point light source; and
the virtual image and the real image are observable from said viewpoint.

2. A two-image-point imaging optical device according to claim 1, wherein each of said dihedral corner reflectors is disposed so that the internal corner formed by two specular surfaces of each of said dihedral corner reflectors faces in the same direction in space on the same side as said point light source with respect to said first plane.

3. A two-image-point imaging optical device according to claim 2, wherein each of said dihedral corner reflectors is disposed so that the bisector of the internal angle formed by two specular surfaces of the dihedral corner reflector coincides with a normal to the first plane.

4. A two-image-point imaging optical device according to claim 1, wherein each of said dihedral corner reflectors is directed to a given direction of rotation about the line of intersection between the two specular surfaces of the dihedral corner reflector within a range in which the two specular surfaces face the point light source.

5. A two-image-point imaging optical device according to claim 1, wherein said dihedral corner reflectors are directed to a predetermined view point or a position between said point light source and said predetermined viewpoint.

6. A two-image-point imaging optical device according to claim 1, wherein the two specular surfaces of each of said dihedral corner reflectors are smooth reflecting mirror surfaces.

7. A two-image-point imaging optical device according to claim 1, wherein each of said dihedral corner reflectors is made of a transparent material having a cross section with a right angle vertex and said two specular surfaces are two smooth surfaces forming the vertex.
